(19) United States
(12) Patent Application Publication
(10) Pub. No.: US 2026/0197667 A1
(43) Pub. Date: Jul. 9, 2026

(54) SCALED SITE DIGITIZATION

(71) Applicants: AT&T Intellectual Property I, L.P., Atlanta, GA (US); AT&T Mobility II LLC, Atlanta, GA (US)

(72) Inventors: AMANDA ABOUJAOUDE, Dallas, TX (US); JAIME OCHOA, CHICAGO, IL (US); SHANE MOONEY, Holly, MI (US); CLINT VINCENT, NORMAN, OK (US); KASIM ROEBUCK, SMYRNA, GA (US); TRAVIS VAN DER WAL, MISSION VIEJO, CA (US); MICHAEL AUZENNE, HOUSTON, TX (US); TRENA PERKINS-STANSBURY, SANFORD, FL (US); Maximiliano Marcos Durazo, Plano, TX (US)

(73) Assignees: AT&T Intellectual Property I, L.P., Atlanta, GA (US); AT&T Mobility II LLC, Atlanta, GA (US)

(21) Appl. No.: 19/010,941

(22) Filed: Jan. 6, 2025

(51) Int. Cl. H04W 16/20

(52) U.S. Cl. CPC H04W 16/20

(57) ABSTRACT

Aspects of the subject disclosure may include, for example, capturing digital data of a mobility network site, forming as-built conditions for the mobility network site, wherein the digital data includes imagery and measurements of the site, generating a three-dimensional (3D) building information modeling (BIM) model of the mobility network site based on the as-built conditions for the mobility network site, comparing the 3D BIM model with design specifications to identify discrepancies between the as-built conditions and the design specifications, updating a database with the 3D BIM model and identified discrepancies to create a digital record of the as-built conditions of the mobility network site, and providing access to the digital record to authorized personnel for use in scoping, design, and quality assurance processes for mobility network site installations and equipment. Other embodiments are disclosed.

### FIELD OF THE DISCLOSURE

The subject disclosure relates to a system and method for scaled digitization of mobility network site installations and equipment.

### BACKGROUND

When planning and building a new mobility network site, or modifying an existing site, the design and scoping process is heavily manual. The resulting data is largely document-based. This combination promotes inaccurate data creation and housing, ultimately increasing company inefficiency. Furthermore, poor data records of how such sites are constructed compared to how they are designed leads to sub-optimal vendor accountability across the mobility space.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of scaled site digitization process which may be used in conjunction with design or modification of one or more aspects of the communications network of FIG. 1 in accordance with various aspects described herein.

FIG. 2B is an image of a building information modeling (BIM) model of a mobility network site developed according to the process of FIG. 2A.

FIG. 2C shows a detailed view of a building information modeling (BIM) model of a mobility network site developed according to the process of FIG. 2A.

FIG. 2D is a detailed image of a building information modeling (BIM) model of a mobility network site developed according to the process of FIG. 2A.

FIG. 2E is a further detailed image of a building information modeling (BIM) model of a mobility network site developed according to the process of FIG. 2A.

FIG. 2F depicts an illustrative embodiment of a method in accordance with various aspects described herein.

FIG. 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for capturing digital data of mobility network sites using unmanned aerial vehicles (UAVs) and ground-based devices including cameras to generate detailed three-dimensional building information modeling (BIM) models. These models may be compared with design specifications to identify discrepancies, which are then stored in a database for subsequent access. Authorized personnel can access this digital record for scoping, design, and quality assurance processes, enhancing the accuracy and efficiency of network site installations and management. Other embodiments are described in the subject disclosure.

One or more aspects of the subject disclosure include capturing digital data of a mobility network site, forming as-built conditions for the mobility network site, wherein the digital data includes imagery and measurements of the site, generating a three-dimensional (3D) building information modeling (BIM) model of the mobility network site based on the as-built conditions for the mobility network site, comparing the 3D BIM model with design specifications to identify discrepancies between the as-built conditions and the design specifications, updating a database with the 3D BIM model and identified discrepancies to create a digital record of the as-built conditions of the mobility network site, and providing access to the digital record to authorized personnel for use in scoping, design, and quality assurance processes for mobility network site installations and equipment.

One or more aspects of the subject disclosure include receiving digital data of a mobility network site, wherein the digital data includes imagery and measurements of the mobility network site, generating a three-dimensional (3D) building information modeling (BIM) model of the mobility network site based on the digital data, wherein the 3D BIM model includes detailed visual representations of the site and its components that may be displayed on a graphical user interface by a user, retrieving, from a database, design specifications for the mobility network site, and comparing the 3D BIM model with the design specifications for the mobility network site to identify discrepancies between an as-built condition of the mobility network site and the design specifications for the mobility network site. Aspects of the subject disclosure further include updating the database with the 3D BIM and identified discrepancies to create a digital record of the as-built condition of the mobility network site, and providing access to the digital record in the database to authorized personnel for use in scoping, design, or quality assurance processes for mobility network site installations and equipment.

One or more aspects of the subject disclosure include receiving digital data of a mobility network site of a mobility network, wherein the digital data includes imagery and measurements of the mobility network site, at least some of the imagery and measurements captured by an unmanned aerial vehicle (UAV), generating a three-dimensional (3D) building information modelling (BIM) model based on the digital data of the mobility network site, comparing the 3D BIM model with a design specification for the mobility network site, identifying one or more discrepancies between an as-built condition of the mobility network site according to the 3D BIM model and the design specification for the mobility network site, and storing information about the one or more discrepancies in a database associated with the mobility network.

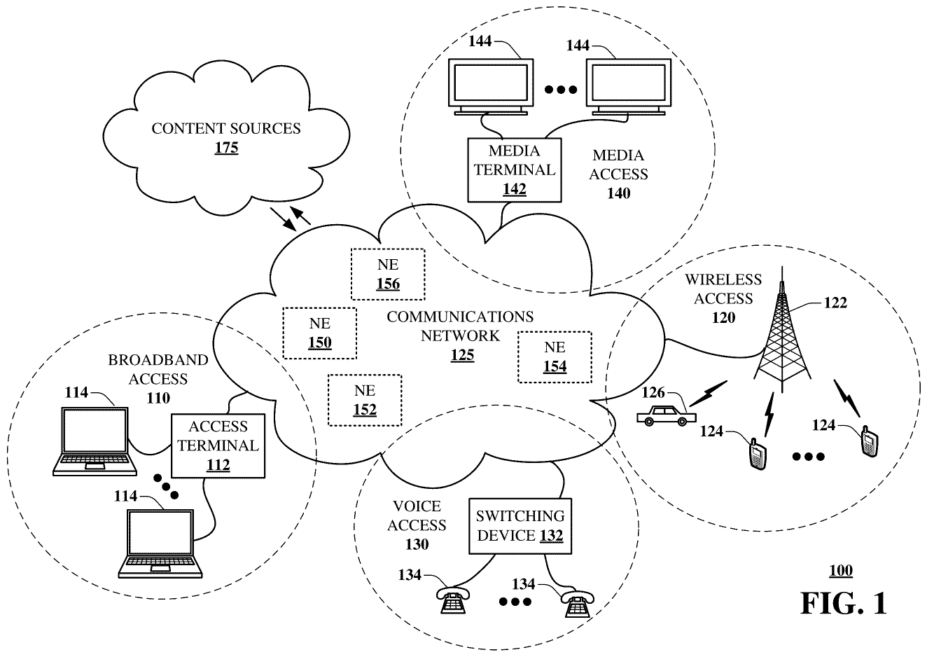

Referring now to FIG. 1, a block diagram is shown illustrating an example, non-limiting embodiment of a system 100 in accordance with various aspects described herein. For example, system 100 can facilitate in whole or in part capturing digital data of mobility network sites, generate detailed three-dimensional models for comparison with design specifications to identify discrepancies. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Managing the build-out and expansion of networks including the communications network 125 has been largely document-based. Expanding the network includes, for example, identifying additional sites for additional mobility network facilities, such as the facilities of wireless access 120. For example, a base station or access point 122 may be designed and built, generating a variety of documentation in the process. When a subsequent base station is required, or the new base station is to be expanded or redesigned, the documentation has been the primary source of information about the mobility network site.

Unfortunately, the process has historically been heavily manual with the resulting data is largely document-based. This combination promotes inaccurate data creation and housing, ultimately increasing inefficiency for the process of building and maintaining network infrastructure including mobility network sites. Furthermore, poor data records of how sites are constructed compared to how they are designed leads to sub-optimal vendor accountability across the mobility space.

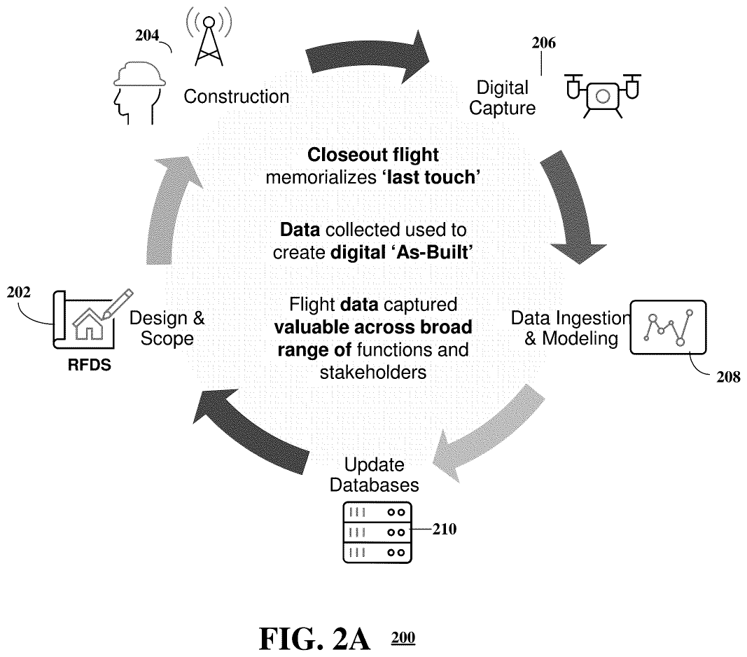

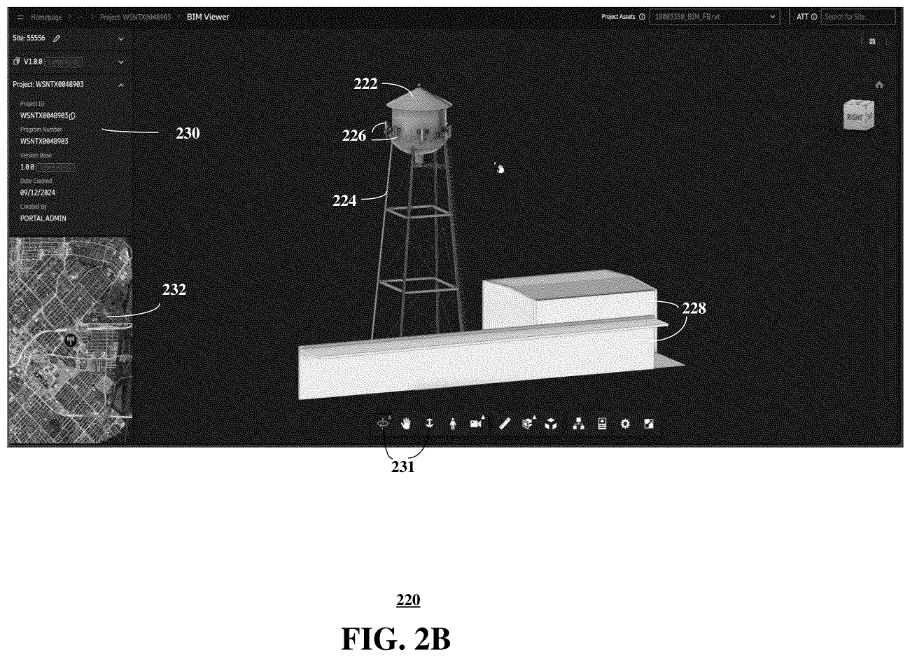

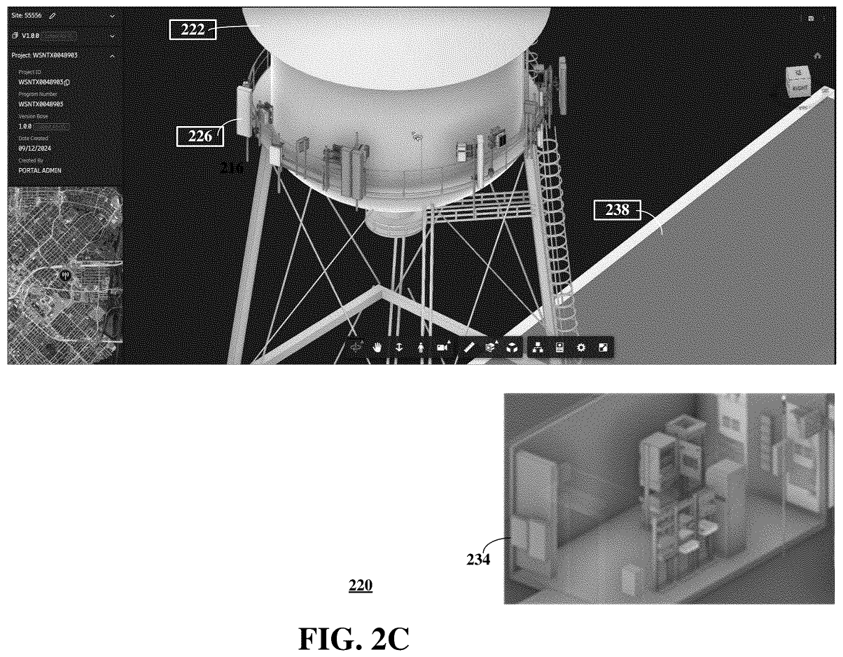

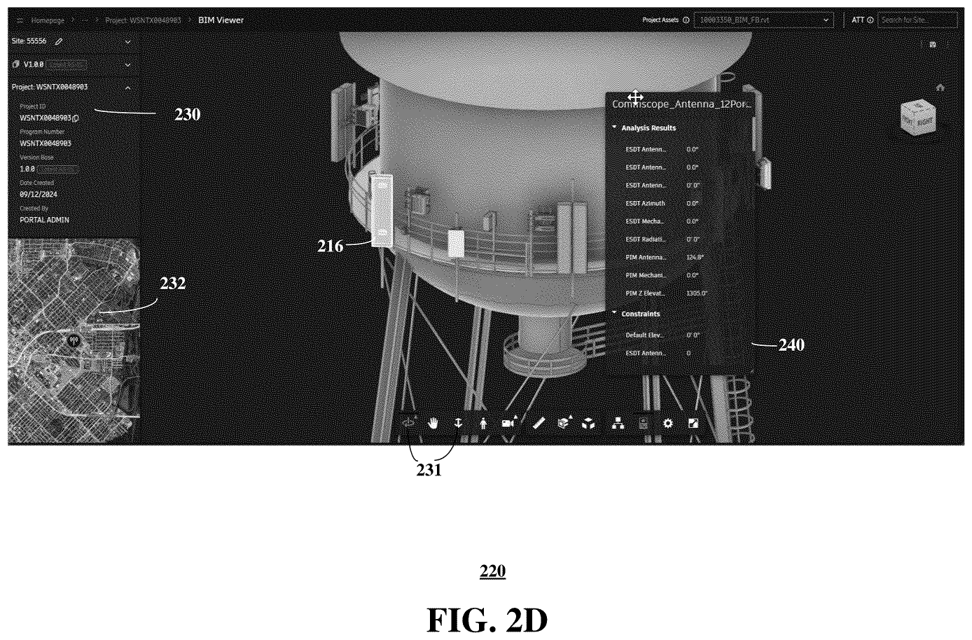

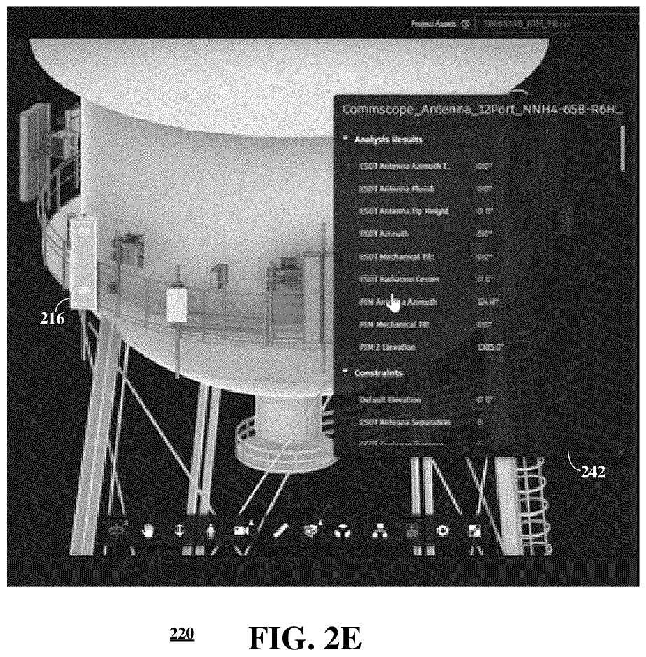

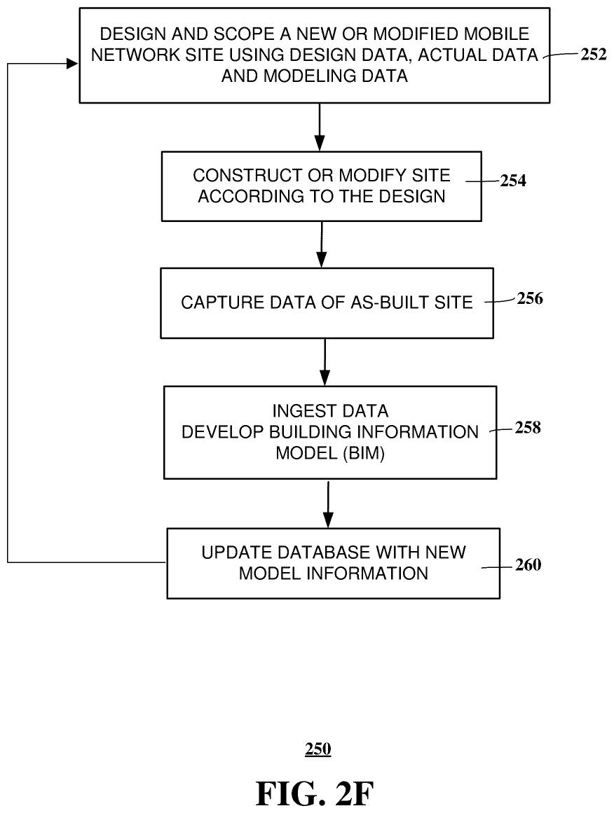

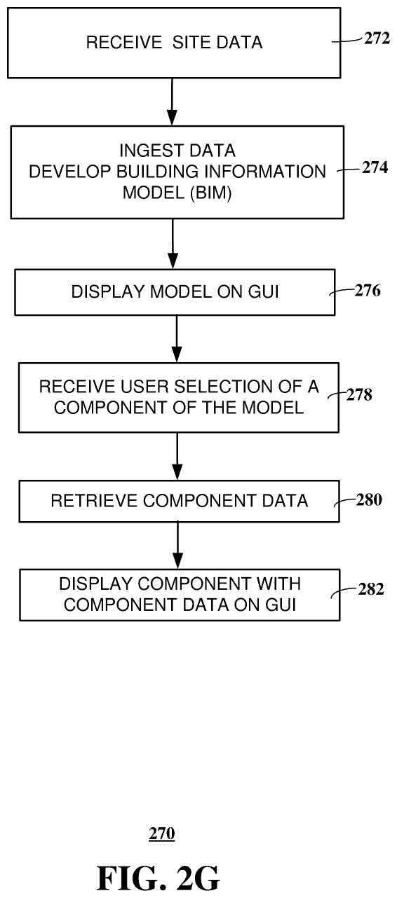

FIG. 2A is a block diagram illustrating an example, non-limiting embodiment of a process 200 that may be performed by any suitable person or persons functioning within the communications network 125 of FIG. 1 in accordance with various aspects described herein. An improved system and method for site development and improvement can be implemented within the communications network 125 depicted in FIG. 1 by utilizing unmanned aerial vehicles (UAVs) and ground-based capture devices to gather digital data of mobility network sites, such as the wireless access 120 provided at base station or access point 122. The captured data, including imagery and measurements, is processed by a system and modeler to generate a three-dimensional (3D) building information modelling (BIM) model of the site. This 3D BIM model may then be compared with design specifications to identify discrepancies, which are stored in a database. Authorized personnel can access this digital record for scoping, design, and quality assurance processes, thereby enhancing the accuracy and efficiency of network site installations and equipment management.

Thus, FIG. 2A illustrates an exemplary, non-limiting embodiment of a scaled site digitization process 200 within the communication network 125 depicted in FIG. 1. The process 200 may be performed by a person or persons. The process 200 may be used for implementing and maintaining and upgrading, over time, a site within a mobility network. The mobility network site may be any facility or infrastructure component or combination of components in the mobility network. For purposes of description herein, a typical site includes a tower equipped with antennas, structures housing equipment such as radio frequency (RF) equipment and electrical power equipment, electrical and mechanical connections to communication networks and power networks, as well as adjacent real estate including access roads, fencing, etc. Obviously, other sites may include alternatives such as micro-sites mounted on street-side poles, switching equipment located in dedicated facilities, base station equipment located in leased space such as a building roof or church spire, and others.

In the example, the process 200 includes a design and scope phase 202, a construction phases 204, a digital capture phase 206, a modeling phase 208, and a data updating phase 210. As indicated in FIG. 2A, the process 200 may be generally cyclical or repetitive as work is done to design and develop and implement a site of the mobility network. Each time a design and build operation is begun, previously stored data from a database or other digital records are retrieved as an input to the new design and build operation. In some applications or instances, one or more of the phases illustrated in FIG. 2A may be omitted or may occur out of order, and other operational phases by be added or substituted. The process 200 of FIG. 2A is intended to be exemplary only.

The process begins with the design and scope phase 202, where initial site plans and specifications are created. This phase involves detailed planning and documentation of the intended design, including the layout, equipment specifications, and other critical parameters necessary for the construction of the mobility network site, such as base station or access point 122. In some examples, the design and scope phase 202 includes identification of suitable locations for siting the mobility network equipment, site acquisition including the purchase or lease of real estate and other relevant rights. In some examples, a site has already been developed but is to be expanded by adding additional facilities or upgraded by replacing existing equipment, such as fourth generation (4G) cellular base station equipment with fifth generation (5G) equipment.

Inputs to the design and scope phase 202 may include design requirements and existing network information. For example, the existing radio frequency (RF) environment may be characterized and used to identify required antenna placement, azimuths and angles at the site. A further input is the existing data about the site including preexisting facilities at the site, as well as information about other, similar or related sites. For example, the site may include some modular components that have been used in design or implementation of other sites and the experience of such prior usage may be incorporated in the existing data maintained in the database. As an example, previous sites may have included variations in the as-built final project from the original design, due to contractor error or unforeseen circumstances. In conventional systems, it has been found that poor data records of how sites are constructed, compared to how they are designed, leads to sub-optimal vendor accountability. These variations may be captured as part of the process 200 and stored in one or more data sources for use in the design and scope phase 202.

Following the design and scope phase 202, the construction phase 204 takes place. During this phase, the physical build of the mobility network site is executed according to the design specifications. This includes the installation of towers, antennas, shelters, cabinets, and other infrastructure components. The construction phase sets the foundation for the subsequent digital capture and modeling processes.

After the construction phase, the digital capture phase 206 is performed using unmanned aerial vehicles (UAVs) and ground-based capture devices. UAVs are deployed to capture high-resolution aerial imagery and measurements of the site, including the tower structures, antennas, and other elevated components. Ground-based capture devices are used to gather detailed data from the ground level, including the exterior and interior views of shelters, cabinets, and the compound. This comprehensive data collection ensures that all aspects of the site are accurately documented.

The digital capture process of the digital capture phase 206 generally comprises site access, physical capture, and the final data upload into a modeling tool. Site access is the precursor to a site being successfully captured, as no data can be collected if a site is not accessible. Before the site visit, technicians may review internal reports for special requirements or access issues that may hinder their ability to perform the capture. This includes acquiring a suitable vehicle for the site location, guaranteeing proper dress for safety, and procuring FAA clearance and necessary permits. When a site cannot be captured for some reason, such as FAA restrictions or weather, it will fall into an exception process so that the logistics of that capture can be reviewed to see if any data can still be partially gathered. Finally, capture technicians generally maintain company identification and a verified approval letter to be allowed on the site to begin work. In some examples, a vendor escort may be required to support the capture technician. Once these prerequisites have been met, the capture technician can start the physical capture.

The physical capture is generally done post-construction (i.e., after construction phase 204) to memorialize the site's as-built conditions. Still, the physical capture can also be done before construction for ad hoc business needs, such as maintenance on a site. A capture checklist may be used and may be standardized to guarantee the same set of necessary data is collected upon each site visit when possible. This allows for less rework later in the modeling process. Additionally, much of the UAV capture portion is automated for consistency.

To perform the capture, the technician utilizes UAVs such as remotely controlled drones, light detection and ranging (LiDAR), and still photography to gather site up-looks, down-looks, centers, overalls, tower site overviews, orbits, cable runs, civils, and access roads. LiDAR is a remote sensing method that uses light in the form of a pulsed laser to measure ranges or variable distances to an object of interest. LiDAR may be used in combination with photogrammetry to characterize the site. For example, the LiDAR equipment emits pulses to measure the distance to objects such as a cell tower or shelter. This creates a dense point cloud representing the terrain and objects on the terrain. Photogrammetry captures overlapping images from various angles. These images contain visual information about the scene. Photogrammetry data processing uses software to analyze the overlapping images and create a three-dimensional (3D) model of the site. This model can include texture and color information.

These captures provide meaningful data, such as antenna azimuths and antenna radiation centerlines. The antenna radiation centerline is the line or path along which the maximum radiation from an antenna is concentrated. An antenna azimuth describes the horizontal angle or direction an antenna points relative to a fixed reference such as true north. Generally, azimuth is measured in degrees on a circular scale from 0 degrees (true north) to 360 degrees, increasing clockwise. The antenna azimuth determines the direction in which the antenna transmits or receives signals. Proper azimuth alignment is crucial for maximizing signal strength and coverage area. Incorrect azimuth can lead to signal interference from other sources. The data captures provide additional imagery around the tower, shelter, cabinets, and compound ultimately utilized to produce end-state outputs. The expected deliverables from the digital capture alone come as raw imagery, spin viewers, and virtual tours.

The captured data is then ingested and modeled at modeling phase 208 to generate a 3D building information model (BIM) model of the site. This step involves processing the imagery and measurements using photogrammetry and other modeling techniques to create a detailed and accurate 3D representation of the site.

After creating the BIM model, in some embodiments, modelers may formulate a computer aided design (CAD) construction drawing that details the site plan, equipment plan, equipment elevation, antenna plan, site elevation, and RF equipment schedule. These outputs are built from templates vetted and approved by internal process teams. This serves as a successor to BIM creation.

Building Information Modeling encompasses the complete process of developing and overseeing information for a building or infrastructure project. It merges detailed, cross-disciplinary data to form a digital model representing an asset, such as a mobility network site or its components, throughout its lifecycle, including planning, design, construction, and operational stages. In typical embodiments, these assets are administered through an open cloud platform that facilitates real-time collaboration, resulting in increased visibility, more informed decision-making, and cost reductions in architecture, engineering, and construction projects.

The BIM model includes precise visual representations of the site and its components, allowing for thorough analysis and comparison with the design specifications. Building Information Modeling (BIM) is a process involving the creation and management of data for a building or infrastructure project throughout its lifecycle. BIM goes beyond simple 3D modeling. It's about creating an intelligent, digital representation of a building, capturing not just its geometry but also its physical and functional characteristics. A BIM model may be thought of as a comprehensive digital blueprint. In embodiments, the BIM model provides a visual representation of the building or structure, including its architecture, structure, and systems. Each element in the BIM model contains detailed information, such as dimensions, materials, and performance characteristics. For example, the BIM model may show physical installation and connection of a particular antenna at the mobility network site. The BIM model stores or has access to full technical details for the antenna, such as its model number, manufacturer specifications for operation. Further, the BIM model may store data about the actual installation of the antenna, including mechanical fixtures by which the antenna is mounted, information about the antenna's power output and azimuth. This information may be compared, for example, with design specifications specified for the design and scope phase 202.

By merging the data gathered through photogrammetry in the site capture process of the digital capture phase 206, with BIM software the process 200 can create a digital model of telecommunication assets, as shown in FIG. 2B, for example, to know the exact conditions of those assets and precise details of every relevant component. The model of the actual site become a digital twin of the actual site. This allows the mobile network operator to maintain a full-scale digital recreation of the mobility network, updating the digital twin as the network evolves.

Once the 3D BIM model is generated, the process moves to the update databases phase 210. In this phase, the BIM model and any identified discrepancies between the as-built conditions and the design specifications are stored in a centralized database or other repository accessible over a network. This digital record serves as a single source of information for the as-built conditions of the mobility network site. The database is accessible to authorized personnel, enabling them to use the digital record for various purposes, including scoping, design, and quality assurance processes.

The updated digital records are valuable across a broad range of functions and stakeholders. For instance, the accurate as-built data can be used to inform future design and scoping activities, ensuring that any modifications or expansions to the site are based on precise and up-to-date information. Additionally, the digital records support quality assurance processes by providing a reliable reference for verifying that the site has been built according to the design specifications. This enhances accountability and reduces the likelihood of errors or discrepancies in the construction process.

Overall, the scaled site digitization process 200 depicted in FIG. 2A provides a comprehensive and accurate method for capturing, modeling, and managing the as-built conditions of mobility network sites. Use of advanced technologies such as UAVs, ground-based capture devices, and BIM modeling, the process ensures that all aspects of the site are accurately documented and accessible for various operational needs. This enhances the efficiency, accuracy, and accountability of network site installations and equipment management.

Discrepancies between the design and the model are identified during the digital capture phase 206, where UAVs and ground-based capture devices gather detailed imagery and measurements of the site 211. The captured data is then ingested and modeled during modeling phase 208 to generate the 3D BIM model of the site. This model is compared with the design specifications to identify discrepancies, which are then stored in a database during the update databases phase 210.

The digital record created from this process provides a single source of truth for the as-built conditions of the mobility network site. Authorized personnel can access this digital record for scoping, design, and quality assurance processes, ensuring that any modifications or expansions to the site are based on precise and up-to-date information. This enhances the accuracy and efficiency of network site installations and equipment management.

FIG. 2B is an image of a building information modeling (BIM) model 220 of a mobility network site developed according to the process of FIG. 2A. The BIM model 220 is displayed in a graphical user interface (GUI). A GUI is a type of user interface that allows users to interact with electronic devices such as a laptop computer through graphical elements like icons, buttons, and menus. Instead of typing commands, users interact with the system by clicking, dragging, and manipulating visual objects on the screen. In the example GUI of FIG. 2B, the interface includes a menu 230, a map view 232 and an elevation view of the BIM model 220. The BIM model 220 illustrates modeled data produced by a modeling phase 208 based on data captured at a mobility network site during a digital capture phase 206 (FIG. 2A). The map view 232 offers a geographical context of the site, showing its location and surroundings.

The BIM model 220 itself includes detailed visual representations of the site and its components. For example, the model shows a tower 222, which is a key structure at the mobility network site. The tower 222 is equipped with various elements such as antennas 226 mounted on support structure 224. Additionally, the BIM model 220 includes representations of other site infrastructure, such as a shelter or building 228.

This BIM model 220 is generated during the data ingestion and modeling phase 208 of the process 200, based on the digital data captured during the digital capture phase 206. The captured data includes imagery and measurements of the site, which are processed to create the detailed 3D representation. The BIM model 220 is then used to compare the as-built conditions with the design specifications, identifying any discrepancies.

Using the GUI, a user may examine detailed portions of the BIM model 220 and see different views. In the illustrated example, the GUI includes view control features 231 for controlling viewing of the display including a rotation control and a zoom control, for example. Any suitable view control features 231 may be included and different view control features 231 may be presented based on the view presented. For example, the user may view a spin viewer, which is a GUI component to allow the user to visualize 3D objects of the model from multiple angles. In effect, the user can spin or rotate the object interactively to view it on the display from all sides. Further, the user can zoom the view in closely on specific areas for a detailed inspection. In another example, the user may view a virtual tour of the model. A virtual tour is a software-based experience that allows users to explore a real or imagined environment virtually. The virtual tour aims to provide a sense of presence and exploration, as if the user were physically within the environment of the model 220. Users can typically navigate through the environment using various methods. For example, in a 360-degree panorama, the user can view scenes from all directions by clicking and dragging or using a mouse wheel. In a walkthrough, the user can navigate through a series of connected scenes, often with a sense of movement and direction, and explore and interact with 3D representations of objects or spaces.

The digital record, including the BIM model 220 and identified discrepancies, may be stored in a database or other suitable storage during the update databases phase 210. Authorized personnel can access this digital record for various purposes, such as scoping, design, and quality assurance processes. This enhances the accuracy and efficiency of network site installations and equipment management, ensuring that the site is built as designed and maintained accurately over time.

FIG. 2C shows a detailed view of the building information modeling (BIM) model 220 of a mobility network site developed according to the scaled site digitization process 200 depicted in FIG. 2A, within the context of the communications network 125 shown in FIG. 1. The top image in FIG. 2C shows a detailed view of the tower 222, which of the mobility network site. The tower 222 is equipped with various elements such as antennas 226. The image also includes a detailed view of the surrounding infrastructure, such as a shelter 238 and support structures. This detailed view is generated during the data ingestion and modeling phase 208, based on the digital data captured during the digital capture phase 206.

The bottom image in FIG. 2C provides a detailed view of the interior of a building or shelter 234 located at the mobility network site. This view includes representations of various equipment and components housed within the shelter 234, providing a comprehensive understanding of the site's infrastructure. This detailed interior view is also part of the BIM model 220, which is used to compare the as-built conditions with the design specifications, identifying any discrepancies. Data for the interior view is collected during the digital capture phase 206 and modeled during the modeling phase 208. Similar to the views of FIG. 2B, a user accessing the GUI may view 3D views at high detail of the interior of the shelter 234. Moreover, the modeling phase 208 may identify any discrepancies between the design for the interior of the shelter 234 and its as-built appearance or construction. Information about such discrepancies may be stored for review by the user or subsequent usage.

Data for the BIM model 220, including these detailed views, is stored in a database during the update databases phase 210. Authorized personnel can access this digital record for various purposes, such as scoping, design, and quality assurance processes, as described in the claims. This enhances the accuracy and efficiency of network site installations and equipment management, ensuring that the site is built as designed and maintained accurately over time.

FIG. 2D is a detailed image of a building information modeling (BIM) model 220 of a mobility network site developed according to the scaled site digitization process 200 depicted in FIG. 2A, within the context of the communications network 125 shown in FIG. 1.

The BIM model 220 is displayed in a graphical user interface (GUI), which allows users to interact with the digital representation of the site. The detailed view in FIG. 2D focuses on specific components of the mobility network site, such as the antenna 216 mounted on the tower 222. The GUI includes a menu 240, which provides various options and tools for navigating and manipulating the BIM model.

In particular, the user may use the GUI to select a particular component or feature of the BIM model 220, such as the antenna 216. For example, the user may use a mouse or touch-screen interface to click on or otherwise select the antenna as an active component. In response to selection of the antenna 216 or other component, the selected active component is highlighted on the user display.

Moreover, in response to selection of the antenna 216 by the user, relevant technical details for the antenna are retrieved from storage, such as in a database. This information may include design information for the antenna, as recorded on design documents that were inputs to the process 200 of FIG. 2A. This information may include as-built information for the antenna determined during the digital capture phase 206 and the modeling phase. For example, information about the manufacturer and model of the antenna 216 is retrieved. Information about the designed azimuth and tilt angle of the antenna 216 is retrieved. Further, information about the actual azimuth and tilt angle is retrieved. As illustrated in FIG. 2D, a popup display 240 may be presented to show some or all of the information retrieved for the antenna 216.

This detailed view is generated during the data ingestion and modeling phase 208, based on the digital data captured during the digital capture phase 206. The captured data includes imagery and measurements of the site, which are processed to create the detailed 3D representation. The BIM model 220 is then used to compare the as-built conditions with the design specifications, identifying any discrepancies.

The digital record, including the BIM model 220 and identified discrepancies, is stored in a database during the update databases phase 210. Authorized personnel can access this digital record for various purposes, such as scoping, design, and quality assurance processes, as described in the claims. This enhances the accuracy and efficiency of network site installations and equipment management, ensuring that the site is built as designed and maintained accurately over time.

FIG. 2E is a further detailed image of the building information modeling (BIM) model 220 of the mobility network site developed according to the process of FIG. 2A. The view of FIG. 2E presents additional details about a selected antenna 216 based on selection of the antenna 216 by a user of a graphical user interface. The BIM model 220 is displayed in the graphical user interface (GUI), which allows users to interact with the digital representation of the site. The detailed view in FIG. 2E focuses on specific components of the mobility network site, such as the antenna 216 mounted on the tower 222. The GUI includes a menu 240, which provides various options and tools for navigating and manipulating the BIM model.

In this detailed view of FIG. 2E, the user can select specific components of the BIM model 220, such as the antenna 216. Upon selection, relevant technical details for the antenna are retrieved from storage, such as in a database. This information may include design information for the antenna, as recorded on design documents that were inputs to the process 200 of FIG. 2A, as well as as-built information determined during the digital capture phase 206 and the modeling phase 208. For example, information about the manufacturer and model of the antenna 216, its designed azimuth and tilt angle, and its actual azimuth and tilt angle can be displayed. Moreover, information such as an antenna tip height and a radiation center axis may be displayed in the example. The popup display 240 in the GUI shows some or all of the information retrieved for the antenna 216. The user can use the menu 230 or view control features 231 to control what information is presented about the selected component.

This detailed view is generated during the data ingestion and modeling phase 208, based on the digital data captured during the digital capture phase 206. The captured data includes imagery and measurements of the site, which are processed to create the detailed 3D representation. The BIM model is then used to compare the as-built conditions with the design specifications, identifying any discrepancies.

FIG. 2F depicts an illustrative embodiment of a method 250 in accordance with various aspects described herein. FIG. 2F illustrates an illustrative embodiment of a method 250 for scaled site digitization of mobility network sites, as described in the context of FIGS. 1 and 2A through 2F. The method 250 may be performed at any suitable device with network access to information about design and build-out of network sites, such as a data processing system of the mobile network operator. The method 250 may be initiated by any suitable user or other process. In an example, the method 250 may be initiated as part of a process to design and scope a new mobile network site or to improve or modify an existing site of the mobile network.

The method begins with step 252, which involves designing and scoping a new or modified mobile network site using design data, actual data, and modeling data. This step may correspond in some respects to the design and scope phase 202 depicted in FIG. 2A, where initial site plans and specifications are created. The design data may include information about the existing network infrastructure, as shown in FIG. 1, and the intended layout and equipment specifications for the new or modified site.

Next, in step 254, the site is constructed or modified according to the design. This step corresponds to the construction phase 204 in FIG. 2A, where the physical build of the mobility network site is executed. The construction includes the installation of towers, antennas, shelters, cabinets, and other infrastructure components. Construction may further include aspects such as acquiring the real estate of the site, developing infrastructure of the site such as roadway access, electric power and connection to a communication network.

Following construction, step 256 involves capturing data of the as-built site. This step 256 may correspond in some respects to the digital capture phase 206 in FIG. 2A, where UAVs and ground-based capture devices are used to gather detailed imagery and measurements of the site. The captured data includes high-resolution aerial imagery and ground-level data, as shown in FIG. 2B and FIG. 2C, for example.

In step 258, the captured data is ingested and used to develop a Building Information Model (BIM) of the site. This step may correspond in some respects to the data ingestion and modeling phase 208 in FIG. 2A. The BIM model includes detailed visual representations of the site and its components, allowing for thorough analysis and comparison with the design specifications, as illustrated in FIG. 2B, FIG. 2C, FIG. 2D, and FIG. 2E, for example.

Finally, in step 260, a database or other storage facility is updated with the new model information. This step corresponds to the update databases phase 210 in FIG. 2A. The BIM model and any identified discrepancies between the as-built conditions and the design specifications may be stored in a centralized database. This digital record serves as a single source of truth for the as-built conditions of the mobility network site, ensuring that authorized personnel can access accurate and up-to-date information for scoping, design, and quality assurance processes.

Overall, FIG. 2F provides a detailed flow of the method 250 for scaled site digitization, linking the various phases and steps illustrated in FIGS. 1 and 2A through 2F, and ensuring the accuracy and efficiency of network site installations and equipment management.

FIG. 2G depicts an illustrative embodiment of a method 270 in accordance with various aspects described herein. FIG. 2G illustrates method 270 for interacting with a Building Information Modeling (BIM) model of a mobility network site, as described in the context of FIGS. 1 and 2A through 2F. The method 270 may be performed at any suitable device with network access to information about design and build-out of network sites, such as a data processing system of the mobile network operator. The method 270 may be initiated by any suitable user or other process. In an example, the method 270 may be initiated as part of the process to design and scope a new mobile network site or to improve or modify an existing site of the mobile network.

The method begins with step 272, which involves receiving site data. This step may correspond in some aspects to the digital capture phase 206 depicted in FIG. 2A, where UAVs and ground-based capture devices gather detailed imagery and measurements of the site, as shown in FIGS. 2B, 2C, and 2D.

Next, in step 274, the captured data is ingested and used to develop a Building Information Model (BIM) of the site. This step corresponds to the data ingestion and modeling phase 208 in FIG. 2A. The BIM model includes detailed visual representations of the site and its components, allowing for thorough analysis and comparison with the design specifications, as illustrated in FIGS. 2C, 2D, 2E, and 2F.

In step 276, the BIM model is displayed on a graphical user interface (GUI). This step involves presenting the detailed 3D representation of the site, as shown in FIGS. 2C, 2D, 2E, and 2F, where users can interact with the model through the GUI. Step 278 involves receiving, at the GUI, a user selection of a component of the model. For example, a user may select an antenna 216 on the tower 222, as depicted in FIG. 2D and FIG. 2E. The GUI allows users to navigate and manipulate the BIM model to select specific components.

In step 280, the system retrieves component data from the database. This data may include, for example, detailed information about the selected component, such as design specifications and as-built conditions. Step 282 involves displaying the selected component with its associated data on the GUI. The user can view technical details and other relevant information about the component, as shown in the popup display 240 in FIGS. 2E and 2F.

Overall, FIG. 2G provides a detailed flow of the method for interacting with the BIM model, linking the various phases and steps illustrated in FIGS. 1 and 2A through 2G, and ensuring the accuracy and efficiency of network site installations and equipment management.

While for purposes of simplicity of explanation, the respective processes are shown and described as a series of blocks in FIG. 2F and FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In embodiments, the method 250 and the method 270 involve capturing digital data of a mobility network site using UAVs and ground-based capture devices. This data includes imagery and measurements of the site. A 3D BIM model is generated based on this data, which is then compared with design specifications to identify discrepancies. The database is updated with the BIM model and discrepancies, creating a digital record of the as-built conditions. Authorized personnel can access this digital record for scoping, design, and quality assurance processes.

In one embodiment, the method includes identifying modifications to the site and updating the BIM model to maintain accuracy. The digital data is captured using UAVs and ground-based devices. LiDAR is used to determine the physical dimensions of site elements. The method includes capturing both exterior and interior views and dimensions of site structures. Embodiments of the method capture information such as azimuth information and radiation centerlines for antennas. The method includes capturing raw imagery, spin viewers for 360-degree views, and virtual tours for panoramic views. Aspects of the method involve displaying the BIM model on a GUI, allowing user navigation and selection of components. Technical details of selected components may be retrieved and displayed. The method includes retrieving and displaying technical data for selected antennas, such as azimuth and tilt information.

The device associated with the method includes UAVs and ground-based capture devices for capturing digital data of a mobility network site. A processing system with a processor and memory receives this data, generates a 3D BIM model, compares it with design specifications, and updates a database with the BIM model and discrepancies. Authorized personnel can access this digital record for various processes.

A non-transitory machine-readable medium in accordance with embodiments herein includes instructions for receiving digital data of a mobility network site, generating a 3D BIM model, comparing it with design specifications, identifying discrepancies, and storing this information in a database.

In one embodiment, the machine-readable medium includes instructions for receiving UAV photos and photogrammetry data. The machine-readable medium includes instructions for receiving raw imagery, spin viewers, and virtual tours. The instructions capture azimuth information and radiation centerlines for antennas, for example.

These methods ensure that the process of capturing, modeling, and managing the as-built conditions of mobility network sites is accurate and efficient, enhancing the overall management of network site installations and equipment.

In additional embodiments, artificial intelligence (AI) and machine learning (ML) techniques can be applied to enhance the process. For example, AI algorithms can be used to automatically identify discrepancies between the as-built conditions and design specifications by analyzing the 3D BIM model and the captured data. Machine learning models can be trained to predict potential issues in the construction phase based on historical data, thereby preventing errors before they occur. AI can also be used to optimize the flight paths of UAVs for more efficient data capture. Furthermore, natural language processing (NLP) can be employed to interpret and act on user commands given through the GUI, making the system more intuitive and user-friendly. These AI and ML enhancements can further improve the accuracy, efficiency, and overall effectiveness of the scaled site digitization process. For example, AI and ML processes may be used to detect and identify anomalies, and to automate quality reviews. In another example, a generative artificial intelligence (gen AI) application may be used for querying data to understand the state of the network or of network components.

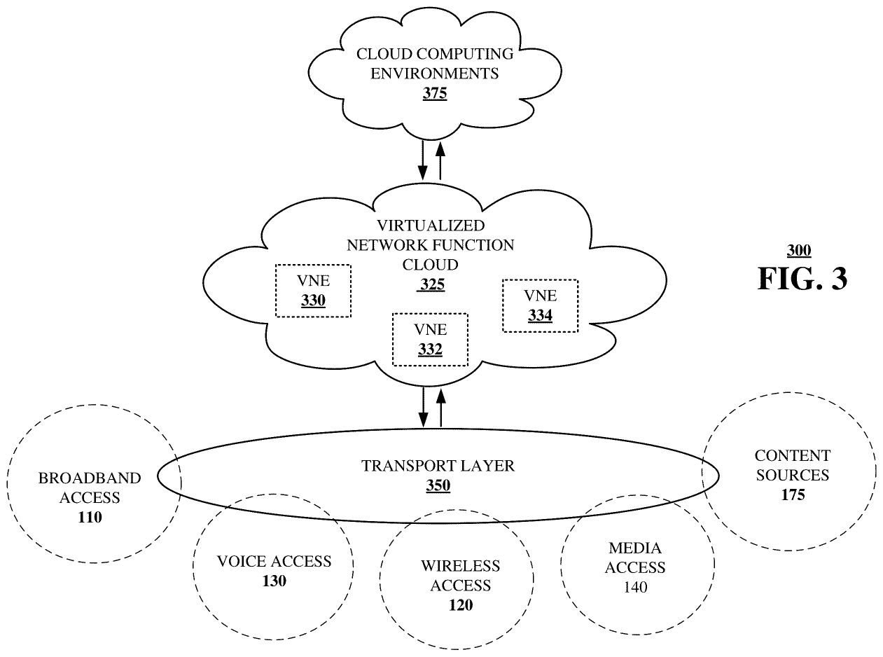

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of process 200, method 250, and method 270 presented in FIG. 1, FIG. 2A, FIG. 2B, FIG. 2C, FIG. 2D, FIG. 2E, FIG. 2F, FIG. 2G, and 3. For example, virtualized communication network 300 can facilitate in whole or in part capturing digital data of mobility network sites, generate detailed three dimensional models for comparison with design specifications to identify discrepancies.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

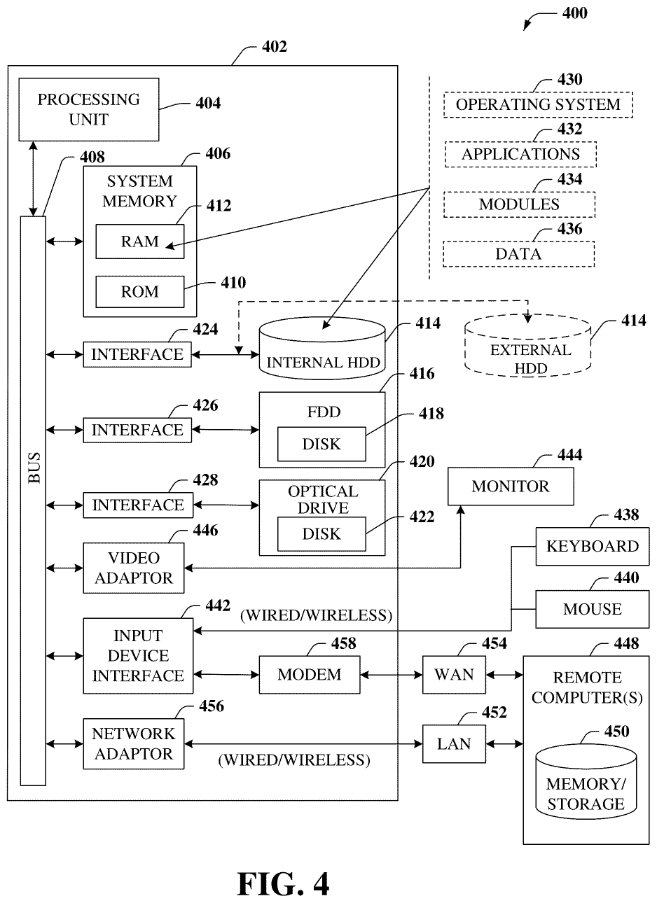

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part capturing digital data of mobility network sites, generate detailed three-dimensional models for comparison with design specifications to identify discrepancies.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10 BaseT wired Ethernet networks used in many offices.

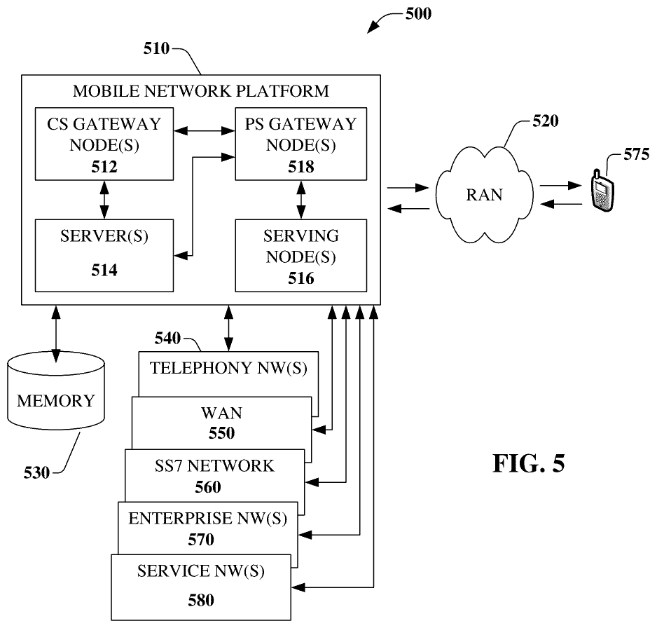

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part capturing digital data of mobility network sites, generate detailed three-dimensional models for comparison with design specifications to identify discrepancies. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

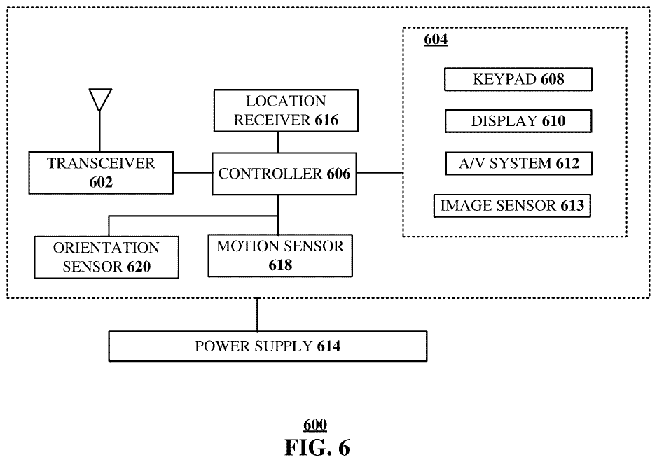

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part capturing digital data of mobility network sites, generate detailed three-dimensional models for comparison with design specifications to identify discrepancies.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
capturing, by a processing system including a processor, digital data of a mobility network site, forming as-built conditions for the mobility network site, wherein the digital data includes imagery and measurements of the site;
generating, by the processing system, a three-dimensional (3D) building information modeling (BIM) model of the mobility network site based on the as-built conditions for the mobility network site;
comparing, by the processing system, the 3D BIM model with design specifications to identify discrepancies between the as-built conditions and the design specifications;
updating, by the processing system, a database with 3D BIM model data and identified discrepancies to create a digital record of the as-built conditions of the mobility network site; and
providing, by the processing system, access to the digital record to authorized personnel for use in scoping, design, and quality assurance processes for mobility network site installations and equipment.

2. The method of claim 1, comprising:
identifying, by the processing system, a modification to facilities of the mobility network site; and
modifying, by the processing system, previous design data of the mobility network site based on the modification to maintain an accurate depiction of the mobility network site.

3. The method of claim 1, wherein the capturing the digital data of a mobility network site comprises:
capturing, by the processing system, the digital data using one or more unmanned aerial vehicles (UAVs) and ground-based capture devices.

4. The method of claim 3, wherein the capturing the digital data of a mobility network site comprises:
determining, by the processing system, physical dimensions of elements of the mobility network site, wherein the determining comprises using light detection and ranging (LiDAR) to generate 3D information about the physical dimensions of elements of the mobility network site.

5. The method of claim 4, wherein the capturing the digital data of a mobility network site comprises:
receiving, by the processing system, information about exterior views and exterior dimensions of structures located at the mobility network site; and
receiving, by the processing system, information about interior views and exterior dimensions of the structures located at the mobility network site.

6. The method of claim 3, wherein the capturing the digital data of a mobility network site comprises:
capturing, by the processing system, azimuth information about one or more antennas of the mobility network site; and
capturing, by the processing system, information about antenna radiation centerlines for the one or more antennas of the mobility network site.

7. The method of claim 1, wherein the capturing the digital data of the mobility network site comprises:
receiving, by the processing system, data forming raw imagery of the mobility network site;
receiving, by the processing system, data forming spin viewers of the mobility network site for display of one or more 360-degree views of portions of the mobility network site; and
receiving, by the processing system, data forming virtual tours of the mobility network site for display of images creating a seamless panoramic view of one or more portions of the mobility network site.

8. The method of claim 1, comprising:
displaying, by the processing system, on a graphical user interface (GUI) one or more components of the 3D BIM model of the mobility network site;
receiving, by the processing system, at the GUI, navigation commands of a user to display a portion of the 3D BIM model;
receiving, by the processing system, at the GUI, a selection by the user of a user-selected component of the portion of the 3D BIM model;
retrieving, by the processing system, from the database, 3D BIM model data for the user-selected component; and
displaying, by the processing system, at the GUI, technical features of the user-selected component, wherein the displaying the technical features is based on the 3D BIM model data for the user-selected component.

9. The method of claim 8, comprising:
receiving, by the processing system, at the GUI, a selection of an antenna as the user-selected component at the mobility network site;
retrieving, by the processing system, from the database, technical data associated with the antenna; and
displaying, by the processing system, at the GUI, the technical data associated with the antenna, wherein displaying the technical data comprises displaying azimuth information and antenna tilt information for the antenna.

10. The method of claim 9, comprising:
receiving, by the processing system, at the GUI, an instruction from the user to modify an installation of the antenna to match a design value for the antenna; and
dispatching, by the processing system, automatically in response to the instruction from the user, technical personnel to modify the installation of the antenna;
receiving, by the processing system, confirmation of a modification to the installation of the antenna; and
updating, by the processing system, the database to reflect the modification to the installation of the antenna.

11. A device, comprising:
a processing system including a processor; and
a memory that stores executable instructions that, when executed by the processing system, facilitate performance of operations, the operations comprising:
receiving digital data of a mobility network site, wherein the digital data includes imagery and measurements of the mobility network site;
generating a three-dimensional (3D) building information modeling (BIM) model of the mobility network site based on the digital data, wherein the 3D BIM model includes detailed visual representations of the site and its components that may be displayed on a graphical user interface by a user;
retrieving, from a database, design specifications for the mobility network site;
comparing the 3D BIM model with the design specifications for the mobility network site to identify discrepancies between an as-built condition of the mobility network site and the design specifications for the mobility network site;
updating the database with the 3D BIM and identified discrepancies to create a digital record of the as-built condition of the mobility network site; and
providing access to the digital record in the database to authorized personnel for use in scoping, design, or quality assurance processes for mobility network site installations and equipment.

12. The device of claim 11, wherein the receiving the digital data of the mobility network site comprises:
receiving the digital data of a mobility network site, including the imagery and measurements, from one or more unmanned aerial vehicles (UAVs) configured to capture digital data of the mobility network site; and
receiving additional imagery and measurements from one or more ground-based capture devices configured to capture additional digital data of the mobility network site.

13. The device of claim 12, wherein the operations further comprise:
using the imagery and measurements of the mobility network site and the additional imagery and measurements to generate the 3D BIM model of the mobility network site, according to a photogrammetry process.

14. The device of claim 11, wherein the operations further comprise:
receiving baseline digital data of the mobility network site, the baseline digital data for supporting an initial design at the mobility network site; and
subsequently, after construction at the mobility network site, receiving post-construction digital data of the mobility network site for supporting network operations in a mobility network including the mobility network site.

15. The device of claim 14, wherein the supporting network operations in a mobility network comprises:
monitoring as-built data retrieved from the 3D BIM model for the mobility network including the mobility network site;
identifying out-of-range as-built data at the mobility network site;
based on the post-construction digital data, correlating the 3D BIM model with design data to identify an installation error at the mobility network site; and
correcting the installation error at the mobility network site.

16. A non-transitory machine-readable medium, comprising executable instructions that, when executed by a processing system including a processor, facilitate performance of operations, the operations comprising:
receiving digital data of a mobility network site of a mobility network, wherein the digital data includes imagery and measurements of the mobility network site, at least some of the imagery and measurements captured by an unmanned aerial vehicle (UAV);
generating a three-dimensional (3D) building information modelling (BIM) model based on the digital data of the mobility network site;
comparing the 3D BIM model with a design specification for the mobility network site;
identifying one or more discrepancies between an as-built condition of the mobility network site according to the 3D BIM model and the design specification for the mobility network site; and
storing information about the one or more discrepancies in a database associated with the mobility network.

17. The non-transitory machine-readable medium of claim 16, wherein the receiving the digital data of the mobility network site comprises:
receiving UAV photos of a cellular base station of the mobility network site; and
receiving photogrammetry measurement data of the cellular base station, including dimensions of tower structures, antennas and buildings at the cellular base station.

18. The non-transitory machine-readable medium of claim 16, wherein the receiving the digital data of the mobility network site comprises:
receiving raw imagery data of the mobility network site;
receiving spin viewer data of the mobility network site for display of one or more 360-degree views of portions of the mobility network site; and
receiving virtual tours data of the mobility network site for display of images creating a seamless panoramic view of one or more portions of the mobility network site.

19. The non-transitory machine-readable medium of claim 16, wherein the receiving the digital data of the mobility network site comprises:
capturing azimuth information about one or more antennas of the mobility network site; and
capturing information about antenna radiation centerlines for the one or more antennas of the mobility network site.

20. The non-transitory machine-readable medium of claim 19, wherein the operations further comprise:
identifying a misaligned antenna, wherein the identifying the misaligned antenna is based on the azimuth information about one or more antennas; and
correcting an alignment of the misaligned antenna.
